(19) United States
(12) Patent Application Publication
(10) Pub. No.: US 2017/0099493 A1
(43) Pub. Date: Apr. 6, 2017

(54) COMPRESSED VIDEO PLAYBACK WITH RAW DATA ASSIST

(71) Applicant: Lattice Semiconductor Corporation, Portland, OR (US)

(72) Inventors: Ju Hwan YI, Sunnyvale, CA (US); Young Don BAE, Sunnyvale, CA (US)

(21) Appl. No.: 15/277,445

(22) Filed: Sep. 27, 2016

Related U.S. Application Data
(60) Provisional application No. 62/235,599, filed on Oct. 1, 2015.

(51) Int. Cl. H04N 19/463; H04N 19/182; H04L 29/06; H04N 19/172

(52) U.S. Cl. CPC H04N 19/463; H04N 19/172; H04N 19/182; H04L 65/601

(57) ABSTRACT

A video processing system has a source device and a sink device. The source device compresses raw video data and transmits the resulting compressed video data and at least some of the raw video data to the sink device. The sink device decompresses the transmitted compressed video data and generates a reconstructed output video frame, where each region of the output frame is based on a selection of either the corresponding raw video data or the corresponding decompressed video data. By using raw video data for some of the regions of the output frame, noticeable artifacts resulting from using a lossy video compression/decompression algorithm can be omitted. In one embodiment, the sink device compares regions of raw and decompressed video data to select data for the output frame and requests the source device to transmit specific regions of new raw video data based on those comparisons.

### CROSS-REFERENCE TO RELATED APPLICATIONS

This application claims the benefit of the filing date of U.S. provisional application No. 62/235,599, filed on Oct. 1, 2015, which is incorporated herein by reference in its entirety for all purposes.

### BACKGROUND

Field

The present invention relates to video processing and, more specifically but not exclusively, to techniques for reducing decompression artifacts resulting from lossy video compression/decompression algorithms.

Description of the Related Art

This section introduces aspects that may help facilitate a better understanding of the invention. Accordingly, the statements of this section are to be read in this light and are not to be understood as admissions about what is prior art or what is not prior art.

FIG. 1 is a simplified block diagram of a conventional video processing system 100 that transmits a sequence of video frames from a source device 110 to a sink device 130 over a transmission path 120 of finite bandwidth. Because the transmission path 120 has finite bandwidth, it is known to apply a video compression algorithm to the sequence of video frames to reduce the amount of data transmitted over that finite-bandwidth transmission path. As shown in FIG. 1, source device 110 comprises a video encoder 110a and a transmitter 110c, while sink device 130 comprises a receiver 130a and a video decoder 130b. The video encoder 110a compresses raw video data 105 to generate compressed video data 110b that the transmitter 110c packages into a compressed video bitstream 115 for transmission over the transmission path 120 to the sink device 130. The receiver 130a receives and unpacks the compressed video bitstream 115 to provide the compressed video data 110b to the video decoder 130b, which decodes the compressed video data 110b to generate decompressed video data 135, for example, for display at the sink device 130.

Many conventional video processing systems, like system 100 of FIG. 1, employ lossy video compression/decompression algorithms that produce artifacts in the decompressed video data that do not exist in the original, raw video data. Such artifacts are more apparent to humans when they appear in graphical imagery with relatively low temporal frequency (e.g., sequences of imagery that are relatively constant) like fine text, lines, and icons, than in natural imagery having relatively high temporal frequency data like motion video. As such, the decompressed video data generated using lossy video compression algorithms for imagery having low temporal frequency data contains artifacts that human viewers easily notice.

### SUMMARY

In one embodiment, the present invention is a source device comprising a video encoder configured to compress raw video data into compressed video data; a communication interface configured to receive the compressed video data for transmission over a communication link to a sink device; and a processor configured to cause a portion of the raw video data to be transmitted over the communication link to the sink device.

In another embodiment, the present invention is a sink device comprising a communication interface configured to receive compressed video data and raw video data over a communication link from a source device; a video decoder configured to decompress the compressed video data into decompressed video data; and a processor configured to generate output video data based on a portion of the decompressed video data and a portion of the raw video data.

In yet another embodiment, the present invention is a method for video processing in a source device of a video processing system, the method comprising compressing raw video data into compressed video data; transmitting the compressed video data; and transmitting a portion of the raw video data.

In yet another embodiment, the present invention is a method for video processing in a sink device of a video processing system, the method comprising receiving compressed video data and raw video data over a communication link from a source device; decompressing the compressed video data into decompressed video data; and generating output video data based on a portion of the decompressed video data and a portion of the raw video data.

### BRIEF DESCRIPTION OF THE DRAWINGS

Embodiments of the invention will become more fully apparent from the following detailed description, the appended claims, and the accompanying drawings in which like reference numerals identify similar or identical elements.

FIG. 1 is a simplified block diagram of a conventional video processing system that transmits a sequence of video frames from a source device to a sink device over a transmission path of finite bandwidth;

FIG. 2 is a representation of an example video frame to be transmitted from a source device to a sink device in a video processing system;

FIG. 3 is a simplified block diagram of a video processing system that transmits a sequence of video frames from a source device to a sink device over a transmission path of finite bandwidth, according to one embodiment of the invention;

FIG. 4 is a representation of the example video frame of FIG. 2 logically divided into regions; and

FIG. 5 is a flow diagram of the processing implemented by the video processing system of FIG. 3.

### DETAILED DESCRIPTION

Detailed illustrative embodiments of the present invention are disclosed herein. However, specific structural and functional details disclosed herein are merely representative for purposes of describing example embodiments of the present invention. The present invention may be embodied in many alternate forms and should not be construed as limited to only the embodiments set forth herein. Further, the terminology used herein is for the purpose of describing particular embodiments only and is not intended to be limiting of example embodiments of the invention.

As used herein, the singular forms “a,” “an,” and “the,” are intended to include the plural forms as well, unless the context clearly indicates otherwise. It further will be understood that the terms “comprises,” “comprising,” “includes,” and/or “including,” specify the presence of stated features, steps, or components, but do not preclude the presence or addition of one or more other features, steps, or components. It also should be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

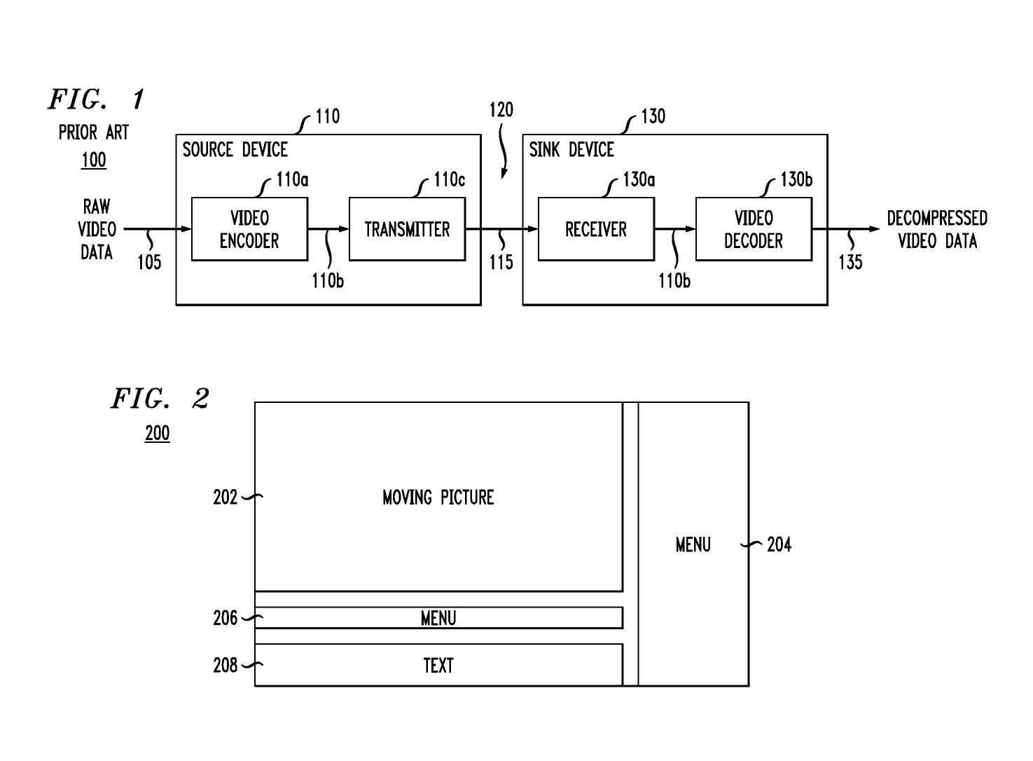

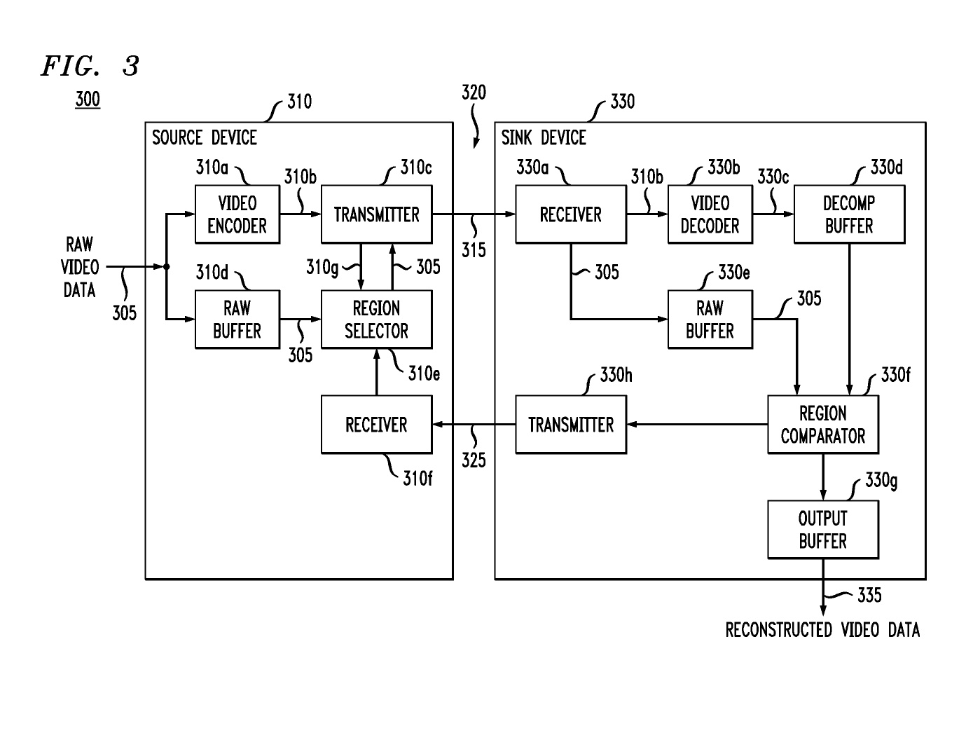

FIG. 2 is a representation of an example video frame 200 to be transmitted from a source device to a sink device in a video processing system, such as system 100 of FIG. 1. In one possible application, video frame 200 is just one frame in a sequence of video frames, where video frame 200 is formed from a current frame in a moving picture stream 202 and three current images corresponding to three different graphical streams 204-208. In general, the moving picture stream will typically (but not always) contain imagery having higher spatial and temporal frequency content than the three graphical streams. When video frame 200 of FIG. 2 is processed using the lossy video processing system 100 of FIG. 1, the decompressed imagery corresponding to the graphical streams will tend to have artifacts that are more noticeable to human viewers than the decompressed imagery corresponding to the moving picture stream.

FIG. 3 is a simplified block diagram of a video processing system 300 that transmits a sequence of video frames from a source device 310 to a sink device 330 over a transmission path 320 of finite bandwidth, according to one embodiment of the invention. In one possible implementation, system 300 employs the same lossy video compression/decompression algorithm as video processing system 100 of FIG. 1, and transmission path 320 is a wired, bidirectional universal serial bus (USB) link. Examples of lossy video compression/decompression algorithms that can be employed in different implementations of video processing system 300 include algorithms conforming to the H.264 video compression standard developed by the ITU-T Video Coding Experts Group (VCEG) together with the ISO/IEC JTC1 Moving Picture Experts Group (MPEG). Those skilled in the art will understand that other suitable lossy video codec algorithms can be employed in still other implementations of video processing system 300.

As shown in FIG. 3, source device 310 comprises a video encoder 310a, a source transmitter 310c, a raw video buffer 310d, a region selector 310e, and a source receiver 310f, while sink device 330 comprises a sink receiver 330a, a video decoder 330b, a decompressed video buffer 330d, a raw video buffer 330e, a region comparator 330f, an output video buffer 330g, and a sink transmitter 330h.

In one possible implementation, video encoder 310a, video decoder 330b, and region comparator 330f are implemented in hardware, while region selector 310e is implemented in software. Other implementations are possible in which each component is implemented in either hardware or software, including those implementations in which video encoder 310a, video decoder 330b, and region comparator 330f are all implemented in software. Note that each of the sink and source transmitters and receivers (310c, 310f, 330a, and 330h) is a communication interface or part of a communication interface having both a physical-layer component as well as a higher-level (e.g., software-based) processor associated with that physical-layer component.

In the source device 310, the video encoder 310a compresses raw video data 305 for the current video frame (e.g., using the same, conventional, lossy, video compression algorithm used in system 100 of FIG. 1) to generate compressed video data 310b that is provided to the source transmitter 310c. Although the raw video data 305 is depicted in FIG. 3 as being applied to the source device 310, depending on the implementation, the raw video data 305 may be generated either internal or external to the source device 310, such as from an external storage device or a WiFi device. The raw video buffer 310d stores the raw video data 305 for the current video frame. The source receiver 310f is capable of receiving requests 325 over transmission path 320 from the sink device 330 for one or more specific regions of raw video data 305.

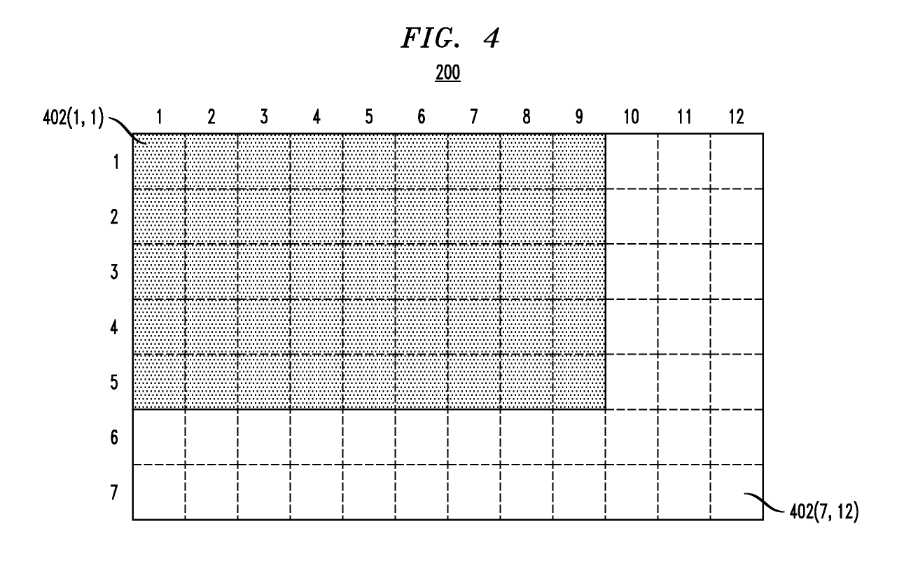

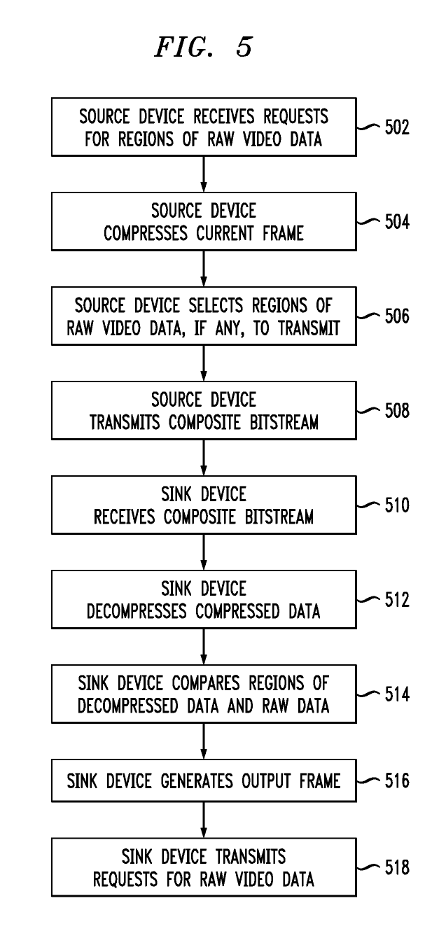

FIG. 4 is a representation of the example video frame 200 of FIG. 2 logically divided into a plurality of (rectangular) regions 402(i,j). In particular, video frame 200 is divided into seven rows and 12 columns of regions, where the 45 regions 402(i,j) for i=1, . . . , 5 and j=1, . . . , 9, correspond to the moving picture stream 202 of FIG. 2 and the 39 remaining regions 402(i,j) correspond to the graphical streams 204-208 of FIG. 2. In certain implementations, each region 402(i,j) corresponds to an (8×8) block of pixels or a (16×16) macroblock of pixels or larger block of pixels in video frame 200. The identity of each region 402(i,j) in video frame 200 may be uniquely identified by its i and j indices.

The region selector 310e determines which if any requests 325 for specific regions of raw video data 305 to accept and, if so, provides the corresponding selected regions of raw video data 305 to the source transmitter 310c, which packages the compressed video data 310b and any selected regions of raw video data 305 into a bitstream 315 for transmission over the transmission path 320 to the sink device 330. Note that the identity of each region (e.g., the region indices) is transmitted along with the corresponding region of raw video data 305.

In one implementation, the source transmitter 310c maintains a transmit buffer (not shown) corresponding to the amount of data to be transmitted to the sink device 330. Those skilled in the art will understand that conventional video compression algorithms generate compressed video data whose size (i.e., number of bits) varies from video frame to video frame depending on the content of those frames. The fullness level of the transmit buffer indicates how much spare bandwidth, if any, is available in the finite-bandwidth transmission path 320 for the transmission of regions of raw video data 305 from the source device 310 to the sink device 330.

The region selector 310e monitors the transmit buffer fullness level 310g and determines how many and which specifically requested regions of raw video data 305 to transmit to the sink device 330. If the transmit buffer fullness level 310g is too high (e.g., above a specified threshold level), then the region selector 310e will determine that no requested regions of raw video data 305 should be transmitted to the sink device 330 for the current video frame. In that case, the bitstream 315 for the current video frame will contain only the compressed video data 310b. If the transmit buffer fullness level 310g indicates that all of the requested regions of raw video data 305 can be transmitted, then the region selector 310e will provide those regions of raw video data 305 stored in the raw video buffer 310d to the source transmitter 310c for inclusion in the bitstream 315.

If the transmit buffer fullness level 310g indicates that only a subset of the requested regions of raw video data 305 can be transmitted, then the region selector 310e determines which requested regions of raw video data 305 to provide to the source transmitter 310c for inclusion in the bitstream 315. In one implementation, the region selector 310e keeps track of the time at which each region of the raw video buffer 310d was last transmitted to the sink device 330 and selects requested regions of raw video data 305 that were transmitted least recently. Note that the raw video buffer 310d stores the raw video data 305 for the current video frame independent of when each region was last transmitted to the sink device 330. When the source device 310 is not able to fulfill all of the requests for regions of raw video data, the source device 310 ignores the unfulfilled requests and waits for the sink device 330 to transmit new requests for those regions.

At the sink device 330, the sink receiver 330a receives and unpacks the bitstream 315 to (i) store the raw video data 305, if any, into the corresponding regions of the raw video buffer 330e (overwriting any stored raw video data 305 from previous video frames) and (ii) provide the compressed video data 310b to the video decoder 330b, which decodes the compressed video data 310b to generate and store decompressed video data 330c for the entire current video frame in the decompressed video buffer 330d.

The region comparator 330f compares, on a region by region basis, the raw video data 305 stored in the raw video buffer 330e with the decompressed video data 330c stored in the decompressed video buffer 330d to determine whether the raw video data is sufficiently similar to the decompressed video data. In one possible implementation, the region comparator 330f compares the pixels of the raw video data 305 with the corresponding pixels of the decompressed video data 330c and applies to different tests to determine whether the raw video data is similar to the decompressed video data.

According to the first test, if the maximum pixel-to-pixel difference magnitude is greater than a specified first threshold value, then the raw video data is determined to be not similar to the decompressed video data. As a very simplified example, if the raw video data has pixel values of (100 102 103 200) and the decompressed video data has pixel values of (101 103 101 199), then the maximum pixel-to-pixel difference magnitude is (103−101) or 2. If the first threshold value is 5, then the first test fails. If, instead, the decompressed video data had pixel values of (101 103 101 190), then the maximum pixel-to-pixel difference magnitude would be (200−190) or 10, and the first test passes.

According to the second test, if a majority of the pixel-to-pixel difference magnitudes are greater than a second threshold value (smaller than first threshold value), then the raw video data is determined to be not similar to the decompressed video data. As a very simplified example, if the second threshold value is 2, and if the raw video data has pixel values of (100 102 103 200) and the decompressed video data has pixel values of (97 106 100 203), then a majority (in this case, all) of the pixel-to-pixel difference magnitudes are greater than 2, and the second test passes.

If either the first test passes or the second test passes or both tests pass, then the raw video data is determined to be not similar to the decompressed video data. If both the first and second tests fail, then the raw video data is determined to be similar to the decompressed video data. There are many other ways to characterize the similarity between raw video data and decompressed video data.

In one possible implementation, the raw video data is in an RGB (red/green/blue) component format, the decompressed video data is in a YCbCr (luma/chroma) 4:2:0 component format, the raw RBG video data is converted to the YCbCr 4:2:0 component format, and the pixel-to-pixel difference magnitudes are calculated between corresponding luma and chroma components.

If the region comparator 330f determines that a region of raw video data 305 and the corresponding region of decompressed video data 330c are sufficiently similar, then the region comparator 330f selects and stores the raw video data 305 into the corresponding region of the output video buffer 330g. On the other hand, if the region comparator 330f determines that the region of raw video data 305 and the corresponding region of decompressed video data 330c are not sufficiently similar, then the region comparator 330f (i) selects and stores the decompressed video data 330c into the corresponding region in the output video buffer 330g and (ii) instructs the sink transmitter 330h to transmit to the source device 310 via the transmission path 320 a request 325 for new raw video data 305 for that region. After all of the regions of the output video buffer 330g have been updated with either raw video data 305 or decompressed video data 330c, the reconstructed video data for the output video frame 335 is ready for display at the sink device 330.

FIG. 5 is a flow diagram of the processing implemented by the video processing system 300 of FIG. 3. In step 502, source device 310 receives requests 325 from sink device 330 for specific regions of raw video data 305. In step 504, source device 310 compresses the raw video data 305 for the current video frame to generate compressed video data 310b. In step 506, source device 310 determines whether or not there is sufficient bandwidth to transmit any regions of raw video data 305 to sink device 330 and, if so, selects one or more regions of raw video data 305 corresponding to the requests 325 received from sink device 330 for inclusion in the bitstream 315 along with the compressed video data 310b. In step 508, source device 310 transmits the bitstream 315 to sink device 330.

In step 510, sink device 330 receives and unpacks the bitstream 315. In step 512, sink device 330 decompresses the compressed video data 310b and stores the resulting decompressed video data 330c into the decompressed video buffer 330d. In step 514, sink device 330 compares each region of decompressed video data 330c to the corresponding region of raw video data 305 to determine whether to select the raw video data 305 or the decompressed video data 330c for the corresponding region of the output video frame 335 generated in step 516. In step 518, sink device 330 transmits to source device 310 requests 325 new raw video data for specific regions. The flow then returns to step 502 to process the next video frame.

When system 300 is initially turned on, for the first pass through the flow diagram of FIG. 5, source device 310 will have received no requests 325 from sink device 330 for any raw video data 305. As such, for the first video frame, source device 310 includes only the compressed video data 310b in the bitstream 315. (Note that, in a possible alternative implementation, source device 310 starts by assuming that it has received requests 325 for raw video data 305 for all of the frame regions.) Since the raw video buffer 330e in sink device 330 is initially empty, when sink device 330 compares the decompressed video data 330c for the first video frame region by region with the empty raw video buffer 330e, sink device 330 will (i) determine that all of the regions are different, (ii) transmit requests 325 to source device 310 for raw video data 305 for all of the regions, and (iii) generate the first reconstructed output video frame based solely on the decompressed video data 330c.

When source device 310 processes the second video frame, there may or may not be sufficient bandwidth for source device 310 to transmit raw video data 305 for all of the regions (or even any of the regions). In any case, over a number of video frames, source device 310 will eventually transmit raw video data 305 for all of the requested regions. At that point, there will be raw video data 305 for each region in raw video buffer 330e in sink device 330.

Referring to example video frame 200 of FIG. 2, for typical video and graphical imagery, sink device 330 will more often select (i) decompressed video data 330c for regions corresponding to the current frame of the moving picture stream 202 and (ii) raw video data 305 for regions corresponding to the current images for the three graphical streams 204-208. As such, sink device 330 will more often transmit requests 325 for regions of raw video data 305 corresponding to the moving picture stream than for the graphical image streams. In this way, the raw video data 305 for the moving picture stream is updated more frequently than the raw video data 305 for the graphical image streams. As such, even though the raw video data 305 corresponding to the moving picture stream will be rarely used to generate the output video frames, if and when sink device 330 determines to use that raw video data 305, it will be more likely to be up-to-date because of its frequent updating. Furthermore, since the imagery of typical graphical image streams 204-208 varies relatively slowly, it is sufficient to update the raw video data 305 in the raw video buffer 330e for those graphical image streams 204-208 only when that graphical imagery does change.

Although the raw video data 305 will typically be selected more for graphical imagery than for moving picture imagery, the video processing of system 300 can be completely agnostic as to the source and type of imagery being processed. When regions of graphical imagery change from frame to frame, such as when a mouse cursor moves across a graphical image or the text of a graphical image is updated, sink device 330 will detect those changes, select the decompressed video data 330c for those regions, and transmit requests 325 for new raw video data 305 for those regions. Similarly, when regions of moving picture imagery are relatively static from frame to frame, such as when a video stream is paused, sink device 330 will select the raw video data 305 for those regions and not transmit requests 325 for new raw video data 305 for those regions.

Regions in which the imagery is changing slowly over time are regions in which compression/decompression artifacts are more noticeable to human viewers. For such regions, the decompressed video data 330c will be relatively similar to the stored raw video data 305, and the stored raw video data 305 will be selected for the output video frame 335, thereby avoiding including those artifacts in the reconstructed video data and providing an output video frame that has a higher quality that a corresponding output video frame constructed using only the decompressed video data 330c.

The invention has been described in the context of an implementation in which the comparisons for both requesting raw video data and constructing the output video frame are based on frame regions of the same size. In other implementations, the size of the regions used for requesting raw video data is different from the size of regions used for constructing the output video frame. For example, in one possible implementation, the regions used for requesting raw video data are (16×16) pixel macroblocks, while the regions used for constructing the output video frame are (8×8) pixel blocks.

The invention has been described in the context of video processing system 300 of FIG. 3, in which sink device 330 (i) determines which regions of raw video data 305 in the sink raw video buffer 330e need to be updated and (ii) transmits requests 325 for those regions to the source device 310. Such an embodiment is especially suitable when a legacy video encoder is implemented in the source device. Note, however, that many conventional video encoders decompress their generated compressed video data as part of the compression algorithm. In that case, decompressed video data, identical to the decompressed video data 330c of FIG. 3, will be available in the source device. As such, in an alternative embodiment of the invention, the source device independently determines which regions of raw video data to transmit to the sink device, and no requests for raw data need to be transmitted from the sink device to the source device. Instead, the source device can instruct the sink device as to which regions of the output video frame should be constructed using decompressed video data and which regions using raw video data. In such an embodiment, the region comparison processing is implemented in the source device rather than the sink device. In addition, the sink device can be implemented without a transmitter 330h and with a region selector like region selector 310e, instead of a region comparator 330f. The source device can also be implemented without a receiver 310f.

As described previously, video processing system 300 can be agnostic as to the type of imagery being processed. In an alternative embodiment, the video processing system selects which regions of raw video data to transmit along with the compressed video data based on knowledge of the imagery type.

The invention has been described in the context of video processing systems that process raw video data corresponding to a stream of video frames. Those skilled in the art will understand that the invention can also be implemented in the context of video processing systems that process raw video data corresponding a sequence of still images, as in a slide show.

Embodiments of the invention may be implemented as (analog, digital, or a hybrid of both analog and digital) circuit-based processes, including possible implementation as a single integrated circuit (such as an ASIC or an FPGA), a multi-chip module, a single card, or a multi-card circuit pack. As would be apparent to one skilled in the art, various functions of circuit elements may also be implemented as processing blocks in a software program. Such software may be employed in, for example, a digital signal processor, micro-controller, general-purpose computer, or other processor.

Integrated circuits have become increasingly complex. Entire systems are constructed from diverse integrated circuit sub-systems. Describing such complex technical subject matter at an appropriate level of detail becomes necessary. In general, a hierarchy of concepts is applied to allow those of ordinary skill to focus on details of the matter being addressed.

Describing portions of a design (e.g., different functional units within an apparatus or system) according to functionality provided by those portions is often an appropriate level of abstraction, since each of these portions may themselves comprise hundreds of thousands, hundreds of millions, or more elements. When addressing some particular feature or implementation of a feature within such portion(s), it may be appropriate to identify substituent functions or otherwise characterize some sub-portion of that portion of the design in more detail, while abstracting other sub-portions or other functions.

A precise logical arrangement of the gates and interconnect (a netlist) implementing a portion of a design (e.g., a functional unit) can be specified. How such logical arrangement is physically realized in a particular chip (how that logic and interconnect is laid out in a particular design) may differ in different process technologies and/or for a variety of other reasons. Circuitry implementing particular functionality may be different in different contexts, and so disclosure of a particular circuit may not be the most helpful disclosure to a person of ordinary skill. Also, many details concerning implementations are often determined using design automation, proceeding from a high-level logical description of the feature or function to be implemented. In various cases, describing portions of an apparatus or system in terms of its functionality conveys structure to a person of ordinary skill in the art. As such, it is often unnecessary and/or unhelpful to provide more detail concerning a portion of a circuit design than to describe its functionality.

Functional modules or units may be composed of circuitry, where such circuitry may be fixed function, configurable under program control or under other configuration information, or some combination thereof. Functional modules themselves thus may be described by the functions that they perform, to helpfully abstract how some of the constituent portions of such functions may be implemented. In some situations, circuitry, units, and/or functional modules may be described partially in functional terms, and partially in structural terms. In some situations, the structural portion of such a description may be described in terms of a configuration applied to circuitry or to functional modules, or both.

Configurable circuitry is effectively circuitry or part of circuitry for each different operation that can be implemented by that circuitry, when configured to perform or otherwise interconnected to perform each different operation. Such configuration may come from or be based on instructions, microcode, one-time programming constructs, embedded memories storing configuration data, and so on. A unit or module for performing a function or functions refers, in some implementations, to a class or group of circuitry that implements the functions or functions attributed to that unit. Identification of circuitry performing one function does not mean that the same circuitry, or a portion thereof, cannot also perform other functions concurrently or serially.

Although circuitry or functional units may typically be implemented by electrical circuitry, and more particularly, by circuitry that primarily relies on transistors fabricated in a semiconductor, the disclosure is to be understood in relation to the technology being disclosed. For example, different physical processes may be used in circuitry implementing aspects of the disclosure, such as optical, nanotubes, micro-electrical mechanical elements, quantum switches or memory storage, magnetoresistive logic elements, and so on. Although a choice of technology used to construct circuitry or functional units according to the technology may change over time, this choice is an implementation decision to be made in accordance with the then-current state of technology.

Embodiments according to the disclosure include non-transitory machine readable media that store configuration data or instructions for causing a machine to execute, or for configuring a machine to execute, or for describing circuitry or machine structures (e.g., layout) that can execute or otherwise perform, a set of actions or accomplish a stated function, according to the disclosure. Such data can be according to hardware description languages, such as HDL or VHDL, in Register Transfer Language (RTL), or layout formats, such as GDSII, for example.

It should be appreciated by those of ordinary skill in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

Unless explicitly stated otherwise, each numerical value and range should be interpreted as being approximate as if the word “about” or “approximately” preceded the value or range.

It will be further understood that various changes in the details, materials, and arrangements of the parts which have been described and illustrated in order to explain embodiments of this invention may be made by those skilled in the art without departing from embodiments of the invention encompassed by the following claims.

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

What is claimed is:

1. A source device comprising:
a video encoder configured to compress raw video data into compressed video data;
a communication interface configured to receive the compressed video data for transmission over a communication link to a sink device; and
a processor configured to cause a portion of the raw video data to be transmitted over the communication link to the sink device.

2. The source device of claim 1, wherein the processor is configured to monitor a utilization of available bandwidth on the communication link to determine which portion of the raw video data to transmit to the sink device.

3. The source device of claim 2, wherein the processor is configured to monitor a transmit buffer level to monitor the utilization of the available bandwidth.

4. The source device of claim 1, wherein:
the communication interface is configured to receive requests from the sink device for specific regions of raw video data to be transmitted to the sink device; and
the processor is configured to determine which received requests to grant and provide the raw video data corresponding to the granted requests to the communication interface for transmission over the communication link to the sink device.

5. A sink device comprising:
a communication interface configured to receive compressed video data and raw video data over a communication link from a source device;
a video decoder configured to decompress the compressed video data into decompressed video data; and
a processor configured to generate output video data based on a portion of the decompressed video data and a portion of the raw video data.

6. The sink device of claim 5, the processor is configured to compare decompressed video data to corresponding raw video data to determine whether to instruct the communication interface to transmit requests to the source device for specific regions of raw video data for transmission to the sink device.

7. The sink device of claim 5, wherein, for each region of a reconstructed output frame, the processor is configured to compare corresponding decompressed video data to corresponding raw video data to determine whether to (i) construct the region using the corresponding decompressed video data or the corresponding raw video data and (ii) request transmission of corresponding new, raw video data for the region from the source device to the sink device.

8. The sink device of claim 7, wherein:
the processor is configured to compare a region of decompressed video data to a corresponding region of raw video data based on inter-region pixel difference magnitudes;
the processor is configured to select decompressed video data for the corresponding region in the reconstructed output frame if the processor determines that a maximum inter-region pixel difference magnitude is greater than a specified first threshold value or a majority of the inter-region pixel difference magnitudes are greater than a specified second threshold value; and
otherwise, the processor is configured to select raw video data for the corresponding region in the reconstructed output frame.

9. A method for video processing in a source device of a video processing system, the method comprising:
compressing raw video data into compressed video data;
transmitting the compressed video data; and
transmitting a portion of the raw video data.

10. The method of claim 9, wherein the compressed video data and the portion of the raw video data are transmitted over a communication link to a sink device of the video processing system.

11. The method of claim 10, further comprising monitoring a utilization of available bandwidth on the communication link to determine which portion of the raw video data to transmit to the sink device.

12. The method of claim 11, wherein monitoring the utilization comprises monitoring a transmit buffer level.

13. The method of claim 10, further comprising:
receiving requests from the sink device for specific regions of raw video data to be transmitted to the sink device;
determining which received requests to grant;
transmitting the raw video data corresponding to the granted requests over the communication link to the sink device.

14. A method for video processing in a sink device of a video processing system, the method comprising:
receiving compressed video data and raw video data over a communication link from a source device;
decompressing the compressed video data into decompressed video data; and
generating output video data based on a portion of the decompressed video data and a portion of the raw video data.

15. The method of claim 14, further comprising comparing decompressed video data to corresponding raw video data to determine whether to transmit requests to the source device for specific regions of raw video data to be transmitted to the sink device.

16. The method of claim 14, comprising comparing, for each region of a reconstructed output frame, corresponding decompressed video data to corresponding raw video data to determine whether to (i) construct the region using the corresponding decompressed video data or the corresponding raw video data and (ii) request transmission of corresponding new, raw video data for the region from the source device.

17. The method of claim 16, comprising:
comparing a region of decompressed video data to a corresponding region of raw video data based on inter-region pixel difference magnitudes;
selecting decompressed video data for the corresponding region in the reconstructed output frame if a maximum inter-region pixel difference magnitude is determined to be greater than a specified first threshold value or if a majority of the inter-region pixel difference magnitudes are determined to be greater than a specified second threshold value; and
otherwise, selecting raw video data for the corresponding region in the reconstructed output frame.
